(19) United States
(12) Patent Application Publication
(10) Pub. No.: US 2024/0274000 A1
(43) Pub. Date: Aug. 15, 2024

(54) SYSTEMS AND METHODS FOR ESTIMATING A TRAFFIC PATTERN FROM SPARSE DATA

(71) Applicant: Denso International America, Inc., Southfield, MI (US)

(72) Inventors: Rajesh Malhan, Troy, MI (US); Mahdi Bandegi, Ann Arbor, MI (US); Patrick Bodun, Placentia, CA (US); Oscar Crowley, Ann Arbor, MI (US)

(21) Appl. No.: 18/506,352

(22) Filed: Nov. 10, 2023

Related U.S. Application Data
(60) Provisional application No. 63/484,249, filed on Feb. 10, 2023.

(51) Int. Cl. G08G 1/01; G06N 3/0464

(52) U.S. Cl. CPC G08G 1/0133; G06N 3/0464; G08G 1/0116; G08G 1/0129; G08G 1/0145

(57) ABSTRACT

Systems, methods, and other embodiments described relate to estimating a traffic pattern using learning models that process data from road sensors that are sparse. In one embodiment, a method includes forming multi-channel data from partial data and timing data about traffic on a road, the partial data acquired from road sensors. The method also includes generating an adjacency matrix from the partial data and geometry about the road. The method also includes training a graph model using temporal patterns for graph nodes from the multi-channel data and the adjacency matrix to complete the partial data and output a traffic pattern estimate.

### CROSS-REFERENCE TO RELATED APPLICATIONS

This application claims the benefit of U.S. Provisional Application No. 63/484,249, filed on, Feb. 10, 2023, which is herein incorporated by reference in its entirety.

### TECHNICAL FIELD

The subject matter described herein relates, in general, to estimating a traffic pattern from sparse data, and, more particularly, to estimating a traffic pattern using learning models that process data from road sensors that are sparse.

### BACKGROUND

Systems utilize sensor data from vehicles, infrastructure, and so on to estimate traffic conditions (e.g., volume, patterns, etc.). For example, pressure sensors on roads generate data that the systems process to track vehicles passing an area for congestion control. Furthermore, cameras acquire images of an intersection for the systems to estimate changes in traffic patterns. However, the sensor data from various sensor types can have gaps due to hardware malfunctions, miscalibrations, and software misreadings. As such, systems that estimate traffic conditions from the sensor data generate inaccurate and unreliable results.

In various implementations, a system implements machine learning (ML) models to fill gaps in the sensor data reflecting traffic conditions. For example, a ML model estimates the gaps by factoring temporal data and location associated with a road and estimates traffic conditions using the remaining data assuming the data is complete. However, ML models may have difficulties filling gaps for damaged sensors or abnormal traffic without information besides the temporal data and the location. Therefore, systems that estimate traffic conditions from sensor data about traffic encounter difficulties when the sensor data is incomplete, such as including gaps.

### SUMMARY

In one embodiment, example systems and methods relate to estimating a traffic pattern using learning models that process data from road sensors that are sparse. In various implementations, systems have difficulties estimating traffic conditions using sensor data that is spare due to gaps and incomplete timeframes. For example, systems acquire partial data from infrastructure sensors such as loop detectors in a road that are defective and estimate inaccurate traffic volume. Furthermore, systems that mitigate prediction shortfalls from the partial data by factoring traffic patterns from the past may estimate conditions having insufficient accuracy for critical applications. (e.g., automated driving).

Therefore, in one embodiment, an estimation system trains a graph model with multi-channel data that is formed from partial data, timing data about traffic, and an adjacency matrix for accurately estimating a traffic pattern. The partial data can originate from road sensors that are malfunctioning on a vehicle, infrastructure equipment, and so on. As such, the estimation system may generate the adjacency matrix from the partial data and geometry about the road. Here, the adjacency matrix relates road junctions and features in a graph for recognizing patterns across space. In one approach, the training involves using temporal patterns for graph nodes associated with the multi-channel data, such as from time-series data. The graph nodes may represent spatial locations of the road sensors amongst a road. Furthermore, the training minimizes losses of the graph model (e.g., a graph convolutional network (GCN)) by comparing the traffic pattern estimated and a ground truth about the partial data. Loss minimization can also include backpropagation which iteratively calculates losses backward through the graph model and makes model adjustments accordingly. Therefore, the estimation system increases prediction accuracy about the traffic pattern by training a graph model to process partial data from road sensors using multi-channel data and an adjacency matrix characterizing traffic.

In one embodiment, an estimation system for estimating a traffic pattern using learning models that process data from road sensors that are sparse is disclosed. The estimation system includes a memory that stores instructions that, when executed by a processor, cause the processor to form multi-channel data from partial data and timing data about traffic on a road, the partial data acquired from road sensors. The instructions also include instructions to generate an adjacency matrix from the partial data and geometry about the road. The instructions also include instructions to train a graph model using temporal patterns for graph nodes from the multi-channel data and the adjacency matrix to complete the partial data and output a traffic pattern estimate.

In one embodiment, a non-transitory computer-readable medium for estimating a traffic pattern using learning models that process data from road sensors that are sparse and including instructions that, when executed by a processor, cause the processor to perform one or more functions is disclosed. The instructions include instructions to form multi-channel data from partial data and timing data about traffic on a road, the partial data acquired from road sensors. The instructions also include instructions to generate an adjacency matrix from the partial data and geometry about the road. The instructions also include instructions to train a graph model using temporal patterns for graph nodes from the multi-channel data and the adjacency matrix to complete the partial data and output a traffic pattern estimate.

In one embodiment, a method for estimating a traffic pattern using learning models that process data from road sensors that are sparse is disclosed. In one embodiment, the method includes forming multi-channel data from partial data and timing data about traffic on a road, the partial data acquired from road sensors. The method also includes generating an adjacency matrix from the partial data and geometry about the road. The method also includes training a graph model using temporal patterns for graph nodes from the multi-channel data and the adjacency matrix to complete the partial data and output a traffic pattern estimate.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of a vehicle in which example systems and methods disclosed herein may operate.

FIG. 2 illustrates one embodiment of an estimation system that is associated with predicting a traffic pattern using learning models that process data from road sensors that are sparse.

FIG. 3 illustrates one embodiment of the estimation system training the graph model using temporal patterns from data and an adjacency matrix for estimating the traffic pattern.

FIGS. 4A and 4B illustrate an example of transforming sensor data to bound information using road sensors.

FIG. 5 illustrates an example of inputs and outputs from training learning models including partial data and the adjacency matrix.

FIG. 6 illustrates one embodiment of a method for estimating the traffic pattern by training the graph model using the temporal patterns from the partial data and the adjacency matrix.

### DETAILED DESCRIPTION

Systems, methods, and other embodiments associated with estimating a traffic pattern using learning models that process data from road sensors that are sparse are disclosed herein. In various implementations, systems predicting a traffic pattern from road sensors encounter incomplete and erroneous data. For example, a loop detector that is faulty communicates signals about traffic crossing over the loop detector with errors. As such, systems process viable portions of the signals excluding errors and estimate incorrectly that the traffic pattern is constant when the traffic pattern is rapidly changing. This creates unsafe conditions for downstream systems performing tasks with the traffic pattern that is erroneously predicted. Additionally, systems implementing learning models that complete the partial data through incorporating temporal patterns about an intersection may estimate a traffic pattern that is insufficient for applications that demand constant reliability (e.g., automated driving).

Therefore, in one embodiment, an estimation system trains a graph model that captures spatio-temporal patterns that are predicted and an adjacency matrix to improve estimates about a traffic pattern derived from partial data. In one approach, the estimation system predicts temporal patterns across time-series data of signal phase and timing (SPaT) data about a road with a neural network (NN) (e.g., a recurrent NN, a convolutional NN, an attention-based NN, etc.) and included in multi-channel data having the partial data. The temporal patterns may be associated with graph nodes representing spatial locations of the road sensors and factor bounds (e.g., lane bounds) that improve the traffic pattern estimated under abnormal conditions, particularly at intersections. For instance, abnormal conditions include increasing pedestrian crossings, prioritizing emergency vehicles, and so on. In these cases, graphing through the multi-channels with signal phase can be leveraged across the graph nodes to spatially preempt patterns. This improves system performance and estimates for the traffic pattern by accurately completing the partial data. Regarding the adjacency matrix, the estimation system generates the adjacency matrix from the partial data acquired from road sensors and the geometry about the road. For example, adjacency is a connectedness measure between the graph nodes derived from travel distance, layout similarity, and so on. As such, the estimation system can identify layout similarity by assessing the connectedness of multiple nodes (e.g., two) through common structure or proximity, thereby improving the traffic pattern estimated by the graph model.

In various implementations, the estimation system groups the road sensors of a lane for the road into a data point. Here, the data point may have complete data, incomplete data, and the partial data that the estimation system transforms into a map having the graph nodes with bound indications. The graph model trains with the map and SPaT data that improves estimates for a traffic pattern. Regarding adjusting weights of the graph model during training, the estimation system can iteratively backpropagate differences between data estimates and ground truths backward through the graph model until reaching an acceptable threshold for losses. Therefore, the estimation system accurately predicts the traffic pattern by training the graph model to process partial data from road sensors generating faulty data using multiple channels and attaining road relationships with an adjacency matrix.

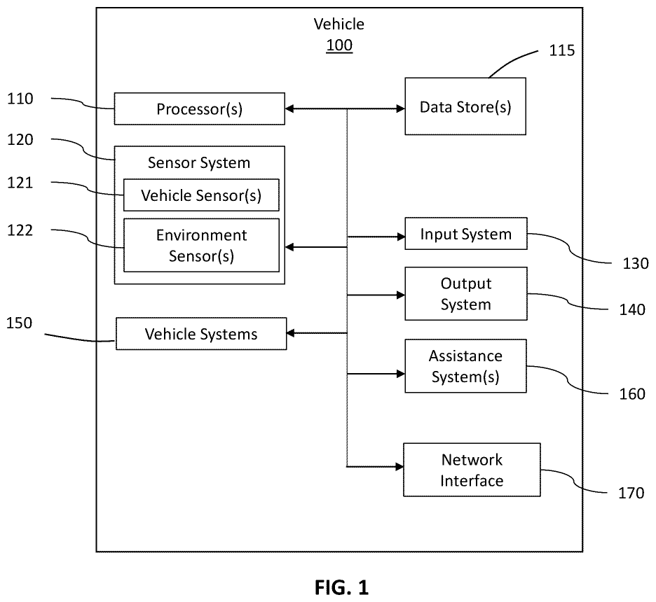

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, an estimation system 200 uses road-side units (RSU), consumer electronics (CE), mobile devices, robots, drones, and so on that benefit from the functionality discussed herein associated with estimating a traffic pattern using learning models that process data from road sensors that are sparse.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment, server, edge server, or other system that is remote from the vehicle 100.

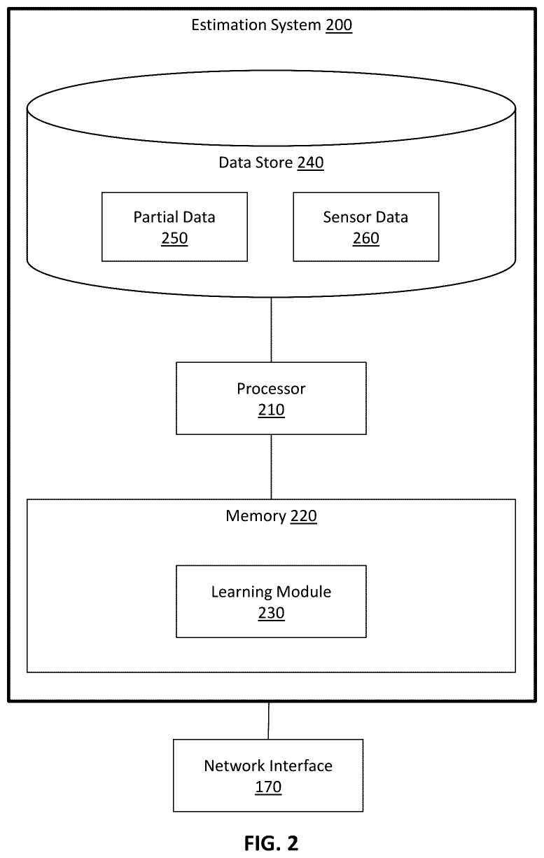

Some of the possible elements of the vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes a network interface 170 that communicates with the estimation system 200 that is implemented to perform methods and other functions as disclosed herein relating to estimating a traffic pattern using learning models that process data from road sensors that are sparse. Moreover, while depicted as a standalone component, in one or more embodiments, the estimation system 200 is a sub-component of another component. The noted functions and methods will become more apparent with a further discussion of the figures.

With reference to FIG. 2, one embodiment of the estimation system 200 is illustrated. The estimation system 200 is shown as including a processor 210 that may be a part of the estimation system 200, the estimation system 200 may include a separate processor from the processor 210 such as in a remote location, and so on. In one or more embodiments, the processor 210 is an application-specific integrated circuit that is configured to implement functions associated with a learning module 230, that will be further described below. More generally, in one or more aspects, the processor 210 is an electronic processor such as a microprocessor that is capable of performing various functions as described herein when executing encoded functions associated with the estimation system 200.

In one embodiment, the estimation system 200 includes a memory 220 that stores a learning module 230. The memory 220 is a random-access memory (RAM), a read-only memory (ROM), a hard-disk drive, a flash memory, or other suitable memory for storing the learning module 230. The learning module 230 is, for example, computer-readable instructions that when executed by the processor 210 cause the processor(s) 210 to perform the various functions disclosed herein.

While, in one or more embodiments, the learning module 230 exists as instructions embodied in the memory 220, in further aspects, the learning module 230 includes hardware, such as processing components (e.g., controllers), circuits, etc. for independently performing one or more of the noted functions. In any case, it should be appreciated that the instructions of the learning module 230 impart structure to the estimation system 200 through correlations of code with the processor 210 and memory in which the estimation system 200 stores the instructions.

The estimation system 200 as illustrated in FIG. 2 is generally an abstracted form of the estimation system 200 as may be implemented, including in a cloud-computing environment. Furthermore, the learning module 230 generally includes instructions that function to control the processor 210 to receive data inputs from one or more sensors of the vehicle 100 through the network interface 170. The inputs are, in one embodiment, observations of one or more objects in an environment proximate to the vehicle 100 and/or other aspects about the surroundings (e.g., an intersection). As provided for herein, the learning module 230, in one embodiment, acquires the sensor data 260 that includes at least camera images, data from road sensors, and so on. In further arrangements, the learning module 230 acquires the sensor data 260 from further sensors such as radar sensors, light detection and ranging (LIDAR) sensors, and other sensors as may be suitable for identifying vehicles and locations of the vehicles. Additionally, the learning module 230 can undertake various approaches to fuse data from multiple sensors when providing the sensor data 260 and/or from sensor data acquired over the network interface 170. For example, the network interface 170 utilizes a wireless or wired connection through one of a V2X protocol (e.g., cellular V2X), a modem of the vehicle 100, RSU modems, dedicated short-range communications (DSRC) protocol, and so on.

Moreover, in one embodiment, the estimation system 200 includes a data store 240. In one embodiment, the data store 240 is a database. The database is, in one embodiment, an electronic data structure stored in the memory 220 or another data store and that is configured with routines that can be executed by the processor 210 for analyzing stored data, providing stored data, organizing stored data, and so on. Thus, in one embodiment, the data store 240 stores data used by the learning module 230 in executing various functions. In one embodiment, the data store 240 includes the sensor data 260 along with, for example, metadata that characterize various aspects of the sensor data 260. For example, the metadata can include location coordinates (e.g., longitude and latitude), relative map coordinates or tile identifiers, time/date stamps from when the separate sensor data 260 was generated, and so on. In one embodiment, the data store 240 further includes the partial data 250 associated with a road, intersection, and so on. For example, the partial data 250 is erroneous data about traffic flow acquired from road sensors that are faulty, malfunctioning, or uncalibrated. The road sensors may be on a vehicle, infrastructure equipment, RSU, loop detector, cameras, and so on that generate data, such as activation times triggered by vehicles for various bounds (e.g., southbound, northbound, etc.). Regarding loop detectors integrated (e.g., buried) into roads, these sensors may degrade due to weather and weight from vehicles that traverse the loop detectors. In this way, the estimation system 200 predicts the traffic flow by comparing differences in the activation times, including traffic flow on a bound-basis.

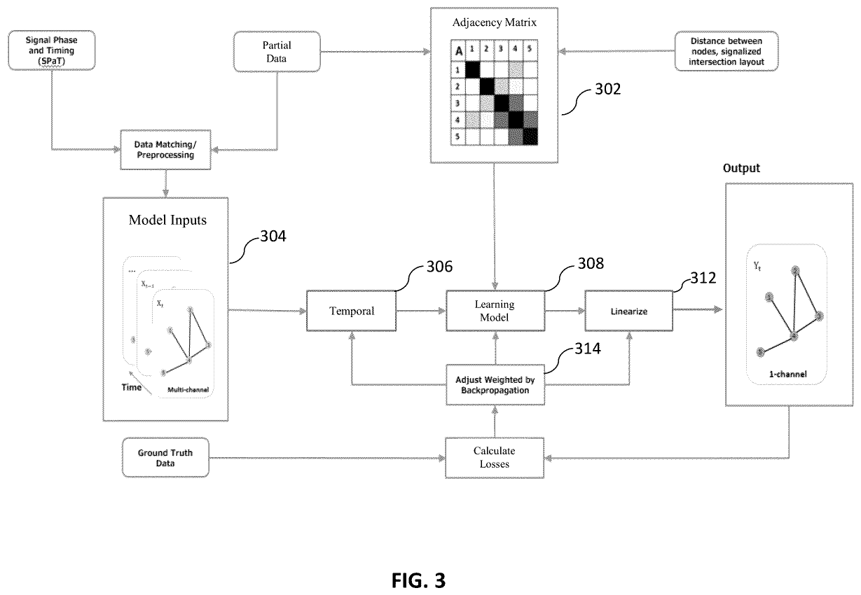

Turning now to FIG. 3, one embodiment of the estimation system 200 training a graph model using temporal patterns from data and an adjacency matrix for estimating a traffic pattern is illustrated. In FIG. 3, the learning model 308 may be a graph model such as a graph convolutional network (GCN), graph-based deep learning, and so on. In other embodiments, the learning model 308 is a data-driven model that estimates a traffic pattern (e.g., volume, flow, etc.) from partial data and an adjacent matrix identifying relationships amongst the partial data. The estimation system 200 and the learning module 230, in one embodiment, include instructions that cause the processor 210 to form multi-channel data from the partial data 250 and timing data about traffic on a road. As further explained below, the instructions also generate an adjacency matrix 302 from the partial data 250 and geometry about the road as A∈R^{N*N}. The road geometry may include curvature, length, width, grade, and so on. As such, input from sources can be preprocessed and matched to generate the input X∈ [symbol] forming the model inputs 304 across time. Here, the input X∈ [symbol] may be a table, matrix, and so on that includes continuous data points for a time-interval. Regarding bounds describing lanes, bound data may have continuous data having varying number of data points from atypical gaps and activation times.

Referring to the function variables, N are nodes in a graph and F_{I} is the length of a feature vector. The variable C represents the input channels as dimensions. In one approach, the dimension of feature vector represents historical time-intervals used by the learning model 308 (e.g., a graph model). As such, F_{I} may be consecutive time-intervals or non-consecutive blocks where recent data points are appended to those from a week, day, etc. ago. Additionally, the input can include any channel that include historical data, SPaT data, the partial data 250, and so on as individual channels. For example, the other channels could be data about abnormal events like emergency vehicle preemptions, pedestrian calls, pedestrian presence, and so on that influence traffic conditions (e.g., volume, patterns, etc.). Regarding computation results, the output may be represented as Y∈ [symbol] , where Fo represents the estimated time-intervals processed concurrently. As such, Fo can be one or several time-intervals.

Regarding the SPaT data, the estimation system 200 factors the SPaT data to improve estimates under abnormal conditions that can negatively skew historical data, particularly at intersections. As signal phase controls become more complex (e.g., prioritizing emergency vehicles, coordinating connected vehicles, and so on), the estimation system 200 refines predictions from RSUs communicating the SPaT data having complex details about switching logic by traffic lights. For example, the estimation system 200 incorporates within the feature vector the fraction of green-signal time at a bound and time-interval from time-series data. Here, the time-series data may be a sequence of data points indexed in chronologically. The data points can be successive measurements acquired from the same source over a fixed time-interval that the estimation system 200 processes to compute changes over time. As such, the estimation system 200 completes the partial data and leads to increasingly accurate estimates for a traffic condition and pattern. Otherwise, time-series variability is lost when the estimation system 200 foregoes accounting of signaling information. The variation in phase timing provide supplementary information to capture the complexity of the time-series data. Furthermore, as explained below, graphing operates across channels that allows the estimation system 200 to factor the SPaT data across nodes and preempt patterns spatially. In one approach, preempting spatial patterns refers to accessing or processing data in a specific spatial order such that system performance is improved.

Regarding further details about generating the adjacency matrix 302, adjacency can represent connectedness between nodes derived from travel distance, layout similarity, correlation of time-series data, and so on. Layout similarity can involve assessing the connectedness between nodes (e.g., representing roads, intersections, etc.) by the similarity structure, geometric proximity, neighborhood, and so on. For example, the estimation system 200 applies more weight to intersections that are close, as reflected by the adjacency matrix 302. In one approach, the estimation system 200 dynamically generates a new adjacency matrix on each estimation based on X. Furthermore, the adjacency matrix 302 can incorporate various inputs depending on a target type for adjacency. For example, the estimation system 200 generates the adjacency matrix 302 according to the travel distance between bounds or similarity of the intersections using details about a road geometry. In another approach, the partial data from an infrastructure sensor data generates the adjacency matrix 302 according to the correlation in the time-series data between multiple bounds (e.g., two).

In one approach, a node within a graph represents the location of an infrastructure sensor, a sensor group, and so on. For example, a node represents an entrance bound of a traffic junction where the sensors for a lane can be grouped into a data point. Here, the estimation system 200 recognizes that a node about a bound is supplying partial data even if one of the sensors is inoperable. As such, the model inputs 304 has multi-channel data formed as graphs that logically relate the partial data 250 and timing data overtime, such as in a time-series form.

In FIG. 3, the estimation system 200 trains the graph model with the temporal 306 block identifying temporal patterns for graph nodes from the model inputs 304 and the adjacency matrix 302. In particular, the temporal 306 block can find patterns in the time-series data for nodes individually, such as a traffic flow by bound. As further explained below, the learning model 308 trains with the outputs from the adjacency matrix 302 and the temporal 306 block to estimate a traffic pattern, thereby leveraging relationships amongst spatial patterns between lanes (e.g., bound shape). The linearizer 312 is a layer that shapes the traffic pattern estimated by the learning model 308 through output reorganization and aggregation, such as at an intersection and bound. The linearizer 312 outputs the traffic pattern, such as traffic flow at an intersection, bound, and movement (e.g., left, right, etc.). In one approach, the estimation system 200 generates the output as discrete data associated with time-intervals instead of continuous from the model inputs 304 that is completed with a similar number of data points about one more or more bounds, time-intervals, and so on.

Regarding details on adjusting model weights, the estimation system 200 compares the output of the learning model 308 against ground truths about the traffic pattern and the partial data 250 and calculates network losses accordingly. For example, the network losses are derived from loss functions that the estimation system 200 utilizes to fit the learning model 308 with the training data. The ground truth may include complete data from road sensors (e.g., simulated data) and the traffic pattern according to the complete data. In one approach, the loss function adjusts the model weights to minimize loss through backpropagation 314. For example, backpropagation iteratively computes differences between data estimates and ground truths backward through the learning model 308 until reaching an acceptable threshold for losses and errors.

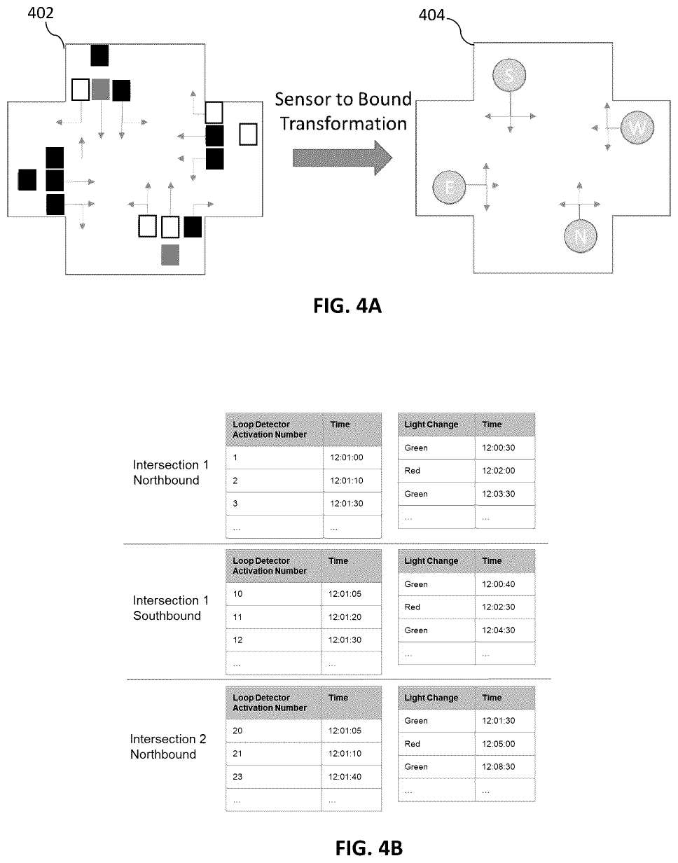

Referring now to FIGS. 4A and 4B, an example of transforming sensor data to bound information using road sensors is illustrated. In FIG. 4A, the road sensors may be infrastructure sensors that the estimation system 200 transforms into nodes within a graph structure. The sensor map 402 includes locations of static sensors, such as loop detectors associated with a stop bar on a road. Advanced detectors (e.g., radar) also acquire data about waiting vehicles at an intersection from a distance (e.g., hundreds of meters). The estimation system 200 can combine data from the loop detectors and the advanced detectors to identify missing patterns for a lane, such as radar missing overlapping vehicles. Furthermore, the sensor map 402 has lane direction for travel and sensor shading indicates an amount of data generated. Here, black indicates accurate measurements and blank indicates data that may be completely missing associated with traffic patterns (e.g., volume, flow, etc.). Gray indicates partial data where the sensor outputs traffic volume measurements that are incorrect. As such, the estimation system 200 transforms the sensor map 402 into a bounds map 404 having north, south, east, and west bounds represented as circles where bounds have partial data summed across sensors. Accordingly, the estimation system 200 can factor the data from the sensor map 402 during training to improve estimates about traffic conditions predicted by the learning model 308.

Moreover, FIG. 4B illustrates timing and phase information acquired by the estimation system 200 associated with bounds (e.g., intersection 1 northbound, intersection 1 southbound, intersection 2 northbound, etc.). In particular, loop detectors integrated into roads may generate timing information (e.g., a timestamp) upon activation when a vehicle travels over the loop detectors. The estimation system 200 processes the timing data and estimates a traffic pattern by comparing differences in activation times, including traffic flow on a bound-basis. Still, the timing data can be incomplete since these sensors degrade due to weather and weight from vehicles that traverse the loop detectors. Accordingly, the estimation system 200 avoids false assumptions that road sensors supply complete data through transforming sensor data, thereby leading to inaccurate estimates about the traffic pattern.

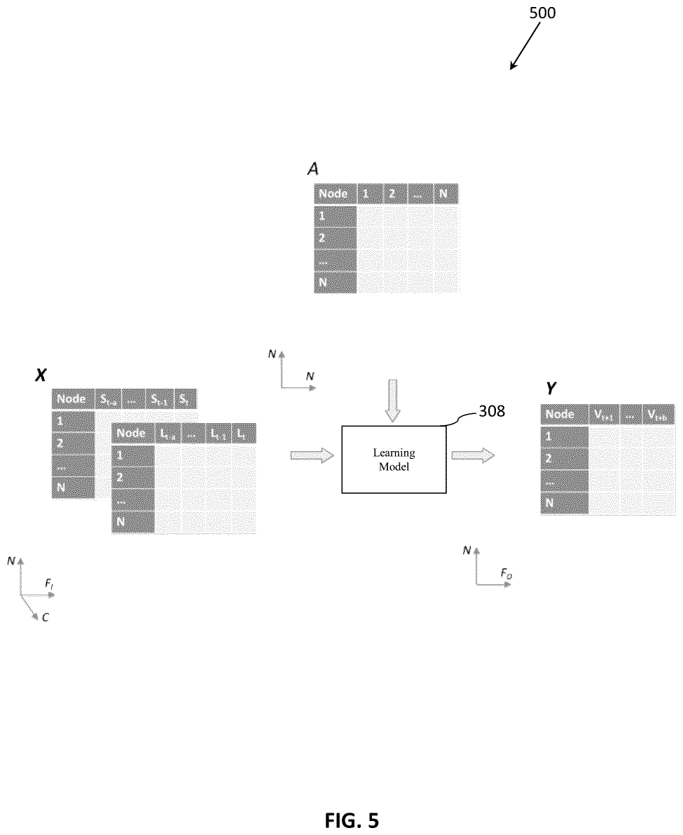

Turning to FIG. 5, an example of inputs and outputs 500 associated with training learning models including partial data and the adjacency matrix 302 having various dimensionalities is illustrated. Here, X is the historical data up to point a as a model input formed within a matrix, table, and so on. For the example in FIG. 5, there are individual channels representing two layers: L represents the partial data from road sensors (e.g., a loop detector) and S represents timing data, such as SPaT data associated with traffic controls. As such, there are two data points for a node and time-interval. F_{I} is the length of a feature vector that can represent time-intervals (e.g., consecutive, non-consecutive, etc.) processed concurrently by the learning model 308 and N is the number of nodes (e.g., bounds). Therefore, the input may have dimensionality 2×N×t for this configuration, where t is time.

Moreover, A is an adjacency matrix that may be a square matrix having size N, location A_{i,j} represents connectedness between the time series for Node i and Node j. In one approach, the represented graph can be weighted, unweighted, directed, undirected, and so on. A weighted graph would result in an adjacency matrix with non-binary values. An undirected graph would result in an adjacency matrix that is symmetrical about the diagonal.

Regarding results, output Y includes the learning model 308 making predictions for N nodes simultaneously, concurrently, and so on. In FIG. 5, the traffic volume is estimated at time f and F_{O}=1, where Fo represents the estimated time-intervals processed concurrently that can be one or multiple time-intervals. Also, traffic volume V may be singular (i.e., t=1), indicate future values up to b, and so on. In one approach, the estimation system 200 increases F_{O} and estimates for a sequence of previous time-intervals concurrently requested by a downstream task (e.g., automated driving). Furthermore, the input and outputs 500 may be discrete, continuous, and so on according to demands by downstream tasks. Accordingly, the estimation system 200 accurately estimates traffic conditions and patterns from partial data about a road by training a learning model to process a flexible amount of time-intervals.

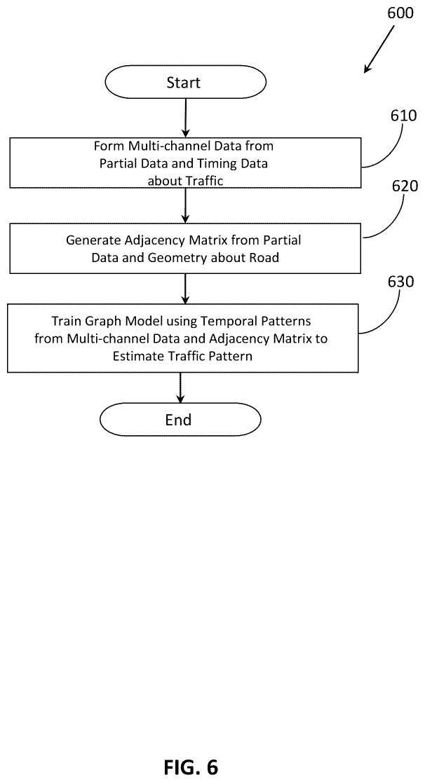

Now turning to FIG. 6, a method 600 will be discussed from the perspective of the estimation system 200, FIG. 1 and FIG. 2. While method 600 is discussed in combination with the estimation system 200, it should be appreciated that the method 600 is not limited to being implemented within the estimation system 200 but is instead one example of a system that may implement the method 600.

At 610, the estimation system 200 forms multi-channel data from partial data and timing data about traffic. For example, the partial data is erroneous data about a traffic pattern (e.g., a traffic flow) that the estimation system 200 acquires from road sensors. The data can be erroneous due to faults, malfunctions, miscalibrations, and so on by the road sensors. In various implementations, the road sensors are on a vehicle, infrastructure equipment, RSU, loop detector, cameras, and so on that generate data, such as activation times triggered by vehicles for various bounds (e.g., southbound, northbound, etc.). Regarding loop detectors, these sensors may degrade due to weather and weight from vehicles that traverse the loop detectors. Furthermore, the timing data can be signaling data acquired from traffic controllers (e.g., traffic lights). Concerning organizing the data, the estimation system 200 can form a channel as an input to a learning model by combining the partial data and the timing data. In this way, the timing data improves estimates about traffic conditions by allowing relationship inferences from the partial data.

At 620, the estimation system 200 generates an adjacency matrix from the partial data and geometry about the road. As previously explained, adjacency can represent connectedness between nodes that represents bounds, roads, intersections, etc. The connectedness can be derived from travel distance, layout similarity, correlation of time-series data, and so on between nodes. For example, the estimation system 200 identifies layout similarity between nodes through assessing structural features, geometric proximity, and so on.

In one approach, the estimation system 200 generates a new adjacency matrix dynamically for each input that includes continuous data points for a time-interval. Furthermore, the adjacency matrix can incorporate various inputs depending on a target type for adjacency. For example, the estimation system 200 generates the adjacency matrix according to the travel distance between bounds or the partial data from an infrastructure sensor data using the correlation in the time-series data between multiple bounds.

Regarding structure, in various implementations, an adjacency matrix is a square matrix having Node i and Node j. As such, location A_{i,j} can represent connectedness between the time series for Node i and Node j. As previously explained, in one approach, the represented graph is weighted, unweighted, directed, undirected, and so on. A weighted graph can be an adjacency matrix with non-binary values. An undirected graph would result in an adjacency matrix that is symmetrical about the diagonal, thereby improving computational efficiency. In this way, the adjacency matrix forms a channel as an input to a learning model that improves estimates about traffic conditions by allowing relationship inferences from the partial data through diverse factors.

At 630, a learning module 230 trains a graph model using temporal patterns from the multi-channel data and the adjacency matrix to estimate a traffic pattern. Besides the graph model, the learning module 230 can also train any learning model (e.g., NN, a deep learning model, etc.) through processing partial data to estimate the traffic pattern. Furthermore, the estimation system 200 can estimate traffic conditions in general. As such, the traffic pattern is a non-limiting example of a traffic condition. Additionally, the temporal patterns may be time-shares data that factors spatial locations of the road sensors and factor bounds (e.g., lane bounds) to improve estimates about traffic conditions under abnormal conditions, particularly those involving intersections. For example, a temporal block can find patterns in the time-series data for nodes that the graph model estimates traffic conditions individually.

Now discussing details about training, the estimation system 200 may complete the model inputs with a similar number of data points for one or more bounds, time-intervals, and so on. Here, the estimation system 200 can compare the output of the graph model against ground truths about the traffic pattern and the partial data to calculate losses accordingly. For instance, the ground truth includes complete data from road sensors and an actual traffic pattern. The losses may be estimates from the graph model that are derived using loss functions. In one approach, a loss function uses backpropagation that factors the model weights to minimize loss. For example, backpropagation iteratively computes differences between data estimates and ground truths backward through the graph model until reaching an acceptable threshold for losses involving the traffic pattern. Accordingly, the estimation system can fit the graph model using the losses and the training data to minimize errors during implementation, thereby improving traffic pattern estimates for downstream tasks demanding accurate outputs from the graph model.

Additionally, it should be appreciated that the estimation system 200 can be configured in various arrangements with separate integrated circuits and/or electronic chips. In such embodiments, the learning module 230 is embodied as a separate integrated circuit. The circuits are connected via connection paths to provide for communicating signals between the separate circuits. Of course, while separate integrated circuits are discussed, in various embodiments, the circuits may be integrated into a common integrated circuit and/or integrated circuit board. Additionally, the integrated circuits may be combined into fewer integrated circuits or divided into more integrated circuits. In another embodiment, the learning module 230 may be combined into a separate application-specific integrated circuit. In further embodiments, portions of the functionality associated with the learning module 230 may be embodied as firmware executable by a processor and stored in a non-transitory memory. In still further embodiments, the learning module 230 is integrated as hardware components of the processor 210.

In another embodiment, the described methods and/or their equivalents may be implemented with computer-executable instructions. Thus, in one embodiment, a non-transitory computer-readable medium is configured with stored computer-executable instructions that, when executed by a machine (e.g., processor, computer, and so on), cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than the illustrated blocks may be used to implement an example methodology. Blocks may be combined or separated into multiple components. Furthermore, additional and/or alternative methodologies can employ additional blocks that are not illustrated.

FIG. 1 will now be discussed in full detail as an example environment within which the systems and methods disclosed herein may operate. In some instances, the vehicle 100 is configured to switch selectively between an automated or autonomous mode, one or more semi-autonomous operational modes, and/or a manual mode. Such switching can be implemented in a suitable manner. “Manual mode” means that all of or a majority of the navigation and/or maneuvering of the vehicle is performed according to inputs received from a user (e.g., human driver or operator).

In one or more embodiments, the vehicle 100 is an automated or autonomous vehicle. As used herein, “automated vehicle” or “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is fully automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store(s) 115 can include volatile and/or non-volatile memory. Examples of suitable data stores 115 include RAM, flash memory, ROM, Programmable ROM (PROM), Erasable Programmable ROM (EPROM), Electrically-Erasable Programmable ROM (EEPROM), registers, magnetic disks, optical disks, hard drives, or any other suitable storage medium, or any combination thereof. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data. The map data can include maps of one or more geographic areas. In some instances, the map data can include information (e.g., metadata, labels, etc.) on roads, traffic control devices, road markings, structures, features, and/or landmarks in the one or more geographic areas. In some instances, the map data can include aerial/satellite views. In some instances, the map data can include ground views of an area, including 360-degree ground views. The map data can include measurements, dimensions, distances, and/or information for one or more items included in the map data and/or relative to other items included in the map data. The map data can include a digital map with information about road geometry. The map data can further include feature-based map data such as information about relative locations of buildings, curbs, poles, etc. In one or more arrangements, the map data can include one or more terrain maps. In one or more arrangements, the map data can include one or more static obstacle maps. The static obstacle map(s) can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, or hills. The static obstacles can be objects that extend above ground level.

The one or more data stores 115 can include sensor data. In this context, “sensor data” means any information from the sensors that the vehicle 100 is equipped with, including the capabilities and other information about such sensors. As noted above, the vehicle 100 can include the sensor system 120. The sensor system 120 can include one or more sensors. “Sensor” means any device, component, and/or system that can detect, perceive, and/or sense something. The one or more sensors can be configured to operate in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself or interior compartments of the vehicle 100. In one or more arrangements, the vehicle sensor(s) 121 can be configured to detect and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a GNSS, a GPS, a navigation system, and/or other suitable sensors. The vehicle sensor(s) 121 can be configured to detect and/or sense one or more characteristics of the vehicle 100. In one or more arrangements, the vehicle sensor(s) 121 can include a speedometer to determine a current speed of the vehicle 100. Moreover, the sensor system 120 can include sensors throughout a passenger compartment such as pressure/weight sensors in seats, seatbelt sensors, camera(s), and so on.

Alternatively, or in addition, the sensor system 120 can include one or more environment sensors 122 configured to acquire and/or sense driving environment data. “Driving environment data” includes data or information about the external environment in which an autonomous vehicle is located or one or more portions thereof. For example, the one or more environment sensors 122 can be configured to detect and/or sense obstacles in at least a portion of the external environment of the vehicle 100 and/or information/data about such obstacles. Such obstacles may be stationary objects and/or dynamic objects. The one or more environment sensors 122 can be configured to detect, and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 can include one or more radar sensors, one or more LIDAR sensors, one or more sonar sensors, and/or one or more cameras. In one or more arrangements, the one or more cameras can be high dynamic range (HDR) cameras or infrared (IR) cameras.

The vehicle 100 can include an input system 130. An “input system” includes, without limitation, devices, components, systems, elements, or arrangements or groups thereof that enable information/data to be entered into a machine. The input system 130 can receive an input from a vehicle passenger (e.g., an operator or a passenger). The vehicle 100 can include an output system 140. An “output system” includes any device, component, or arrangement or groups thereof that enable information/data to be presented to a vehicle passenger (e.g., a person, a vehicle passenger, etc.).

The vehicle 100 can include one or more vehicle systems 150. Various examples of the one or more vehicle systems 150 are shown in FIG. 1; however, the vehicle 100 can include a different combination of systems than illustrated in the provided example. In one example, the vehicle 100 can include a propulsion system, a braking system, a steering system, a throttle system, a transmission system, a signaling system, a navigation system, and so on. The noted systems can separately or in combination include one or more devices, components, and/or a combination thereof.

By way of example, the navigation system can include one or more devices, applications, and/or combinations thereof configured to determine the geographic location of the vehicle 100 and/or to determine a travel route for the vehicle 100. The navigation system can include one or more mapping applications to determine a travel route for the vehicle 100. The navigation system can include a GPS, a local positioning system or a geolocation system.

The processor(s) 110 and/or the assistance system(s) 160 can be operatively connected to communicate with the various vehicle systems 150 and/or individual components thereof. For example, returning to FIG. 1, the processor(s) 110 and/or the assistance system(s) 160 can be in communication to send and/or receive information from the various vehicle systems 150 to control the movement, speed, maneuvering, heading, direction, etc. of the vehicle 100. The processor(s) 110 and/or the assistance system(s) 160 may control some or all of these vehicle systems 150 and, thus, may be partially or fully autonomous.

The processor(s) 110 and/or the assistance system(s) 160 can be operatively connected to communicate with the various vehicle systems 150 and/or individual components thereof. For example, returning to FIG. 1, the processor(s) 110 and/or the assistance system(s) 160 can be in communication to send and/or receive information from the various vehicle systems 150 to control the movement, speed, maneuvering, heading, direction, etc. of the vehicle 100. The processor(s) 110 and/or the assistance system(s) 160 may control some or all of these vehicle systems 150.

The processor(s) 110 and/or the assistance system(s) 160 may be operable to control the navigation and/or maneuvering of the vehicle 100 by controlling one or more of the vehicle systems 150 and/or components thereof. For instance, when operating in an autonomous mode, the processor(s) 110 and/or the assistance system(s) 160 can control the direction and/or speed of the vehicle 100. The processor(s) 110 and/or the assistance system(s) 160 can cause the vehicle 100 to accelerate (e.g., by increasing the supply of energy provided to the engine), decelerate (e.g., by decreasing the supply of energy to the engine and/or by applying brakes), and/or change direction (e.g., by turning the front two wheels).

Moreover, the estimation system 200 and/or the assistance system(s) 160 can function to perform various driving-related tasks. The vehicle 100 can include one or more actuators. The actuators can be any element or combination of elements operable to modify, adjust and/or alter one or more of the vehicle systems or components thereof responsive to receiving signals or other inputs from the processor(s) 110 and/or the assistance system(s) 160. Any suitable actuator can be used. For instance, the one or more actuators can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include the assistance system(s) 160. The assistance system(s) 160 can be configured to receive data from the sensor system 120 and/or any other type of system capable of capturing information relating to the vehicle 100 and/or the external environment of the vehicle 100. In one or more arrangements, the assistance system(s) 160 can use such data to generate one or more driving scene models. The assistance system(s) 160 can determine the position and velocity of the vehicle 100. The assistance system(s) 160 can determine the location of obstacles, or other environmental features, including traffic signs, trees, shrubs, neighboring vehicles, pedestrians, and so on.

The assistance system(s) 160 can be configured to receive, and/or determine location information for obstacles within the external environment of the vehicle 100 for use by the processors 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The assistance system(s) 160 can be configured to determine travel path(s), current autonomous driving maneuvers for the vehicle 100, future autonomous driving maneuvers, and/or modifications to current autonomous driving maneuvers based on data acquired by the sensor system 120, driving scene models, and/or data from any other suitable source such as determinations from sensor data. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The assistance system(s) 160 can be configured to implement determined driving maneuvers. The assistance system(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The assistance system(s) 160 can be configured to execute various vehicle functions and/or to transmit data to, receive data from, interact with, and/or control the vehicle 100 or one or more systems thereof (e.g., one or more of vehicle systems 150).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, another magnetic medium, an application-specific integrated circuit (ASIC), a CD, another optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that, when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An estimation system, comprising:
a memory storing instructions that, when executed by a processor, cause the processor to:
form multi-channel data from partial data and timing data about traffic on a road, the partial data acquired from road sensors;
generate an adjacency matrix from the partial data and geometry about the road; and
train a graph model using temporal patterns for graph nodes from the multi-channel data and the adjacency matrix to complete the partial data and output a traffic pattern estimate.

2. The estimation system of claim 1 further including instructions to estimate the temporal patterns by a learning model from time-series data associated with the graph nodes individually, and the graph nodes represent spatial locations of the road sensors between lane bounds associated with the road.

3. The estimation system of claim 2 further including instructions to:
group the road sensors of a lane for the road into a data point, and the data point having complete data, incomplete data, and the partial data, and the road sensors include devices that are malfunctioning on a vehicle and infrastructure equipment; and
transform the data point into a map having the graph nodes that includes bound nodes for the road.

4. The estimation system of claim 1, wherein the instructions to train the graph model further include instructions to:
process historical data that factors bounds represented by the graph nodes, a length of a feature vector, and channels producing the multi-channel data; and
minimize a loss of the graph model by comparing the historical data and the traffic pattern against a ground truth about the partial data.

5. The estimation system of claim 4, wherein the feature vector represents a number of time-intervals and the time-intervals are one of consecutive time-intervals and non-consecutive blocks.

6. The estimation system of claim 1 further including instructions to derive the adjacency matrix using a relationship between the graph nodes that factors any one of a travel distance, a road layout, and a time-series correlation.

7. The estimation system of claim 1 further including instructions to shape the traffic pattern at an intersection and bound individually by a linearizing layer of the graph model.

8. The estimation system of claim 1, wherein the timing data indicates any one of vehicle prioritization, vehicle platooning, pedestrian crossings, and fractional phases of a traffic light associated with a time-interval that represents abnormal conditions for the traffic.

9. The estimation system of claim 1, wherein the road sensors are infrastructure sensors that are malfunctioning, the timing data is signal phase and timing (SPaT) data for a signalized intersection associated with the road, and the traffic pattern is traffic volume.

10. A non-transitory computer-readable medium comprising:
instructions that, when executed by a processor, cause the processor to:
form multi-channel data from partial data and timing data about traffic on a road, the partial data acquired from road sensors;
generate an adjacency matrix from the partial data and geometry about the road; and
train a graph model using temporal patterns for graph nodes from the multi-channel data and the adjacency matrix to complete the partial data and output a traffic pattern estimate.

11. The non-transitory computer-readable medium of claim 10 further including instructions to estimate the temporal patterns by a learning model from time-series data associated with the graph nodes individually, and the graph nodes represent spatial locations of the road sensors between lane bounds associated with the road.

12. A method comprising:
forming multi-channel data from partial data and timing data about traffic on a road, the partial data acquired from road sensors;
generating an adjacency matrix from the partial data and geometry about the road; and
training a graph model using temporal patterns for graph nodes from the multi-channel data and the adjacency matrix to complete the partial data and output a traffic pattern estimate.

13. The method of claim 12 further comprising estimating the temporal patterns by a learning model from time-series data associated with the graph nodes individually, and the graph nodes represent spatial locations of the road sensors between lane bounds associated with the road.

14. The method of claim 13 further comprising:
grouping the road sensors of a lane for the road into a data point, and the data point having complete data, incomplete data, and the partial data, and the road sensors include devices that are malfunctioning on a vehicle and infrastructure equipment; and
transforming the data point into a map having the graph nodes that includes bound nodes for the road.

15. The method of claim 12, wherein training the graph model further includes:
processing historical data that factors bounds represented by the graph nodes, a length of a feature vector, and channels producing the multi-channel data; and
minimizing a loss of the graph model by comparing the historical data and the traffic pattern against a ground truth about the partial data.

16. The method of claim 15, wherein the feature vector represents a number of time-intervals and the time-intervals are one of consecutive time-intervals and non-consecutive blocks.

17. The method of claim 12 further comprising deriving the adjacency matrix using a relationship between the graph nodes that factors any one of a travel distance, a road layout, and a time-series correlation.

18. The method of claim 12 further comprising shaping the traffic pattern at an intersection and bound individually by a linearizing layer of the graph model.

19. The method of claim 12, wherein the timing data indicates any one of vehicle prioritization, vehicle platooning, pedestrian crossings, and fractional phases of a traffic light associated with a time-interval that represents abnormal conditions for the traffic.

20. The method of claim 12, wherein the road sensors are infrastructure sensors that are malfunctioning, the timing data is signal phase and timing (SPaT) data for a signalized intersection associated with the road, and the traffic pattern is traffic volume.
